(19) United States
(12) Patent Application Publication
(10) Pub. No.: US 2008/0062171 A1
(43) Pub. Date: Mar. 13, 2008

(54) Method for simplifying maintenance of feature of three-dimensional mesh data

(75) Inventor: Soo-Kyun Kim, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/894,925

(22) Filed: Aug. 22, 2007

(30) Foreign Application Priority Data
Sep. 12, 2006 (KR) 2006-88012

(51) Int. Cl. G06T 17/20

(52) U.S. Cl. 345/423

(57) ABSTRACT

A method for simplifying the maintenance of a feature of three-dimensional mesh data includes: receiving an input of three-dimensional mesh data from a three-dimensional range scanning system; creating a surface approximated with regard to points of the mesh data; measuring the curvature and curvature derivative value for respective points on the created surface; measuring zero-crossing at the edge of the mesh data so as to extract feature points; connecting the feature points in the curvature direction so as to create a feature line; and calculating the edge and quadric error metric regarding the feature line so as to simplify the maintenance of the feature of the model. A complicated three-dimensional mesh model is simplified at a level desired by a user so as to reduce the time and cost related to manual treatment of a three-dimensional geometric model by a designer.

### CLAIM OF PRIORITY

This application claims the benefit under 35 U.S.C. §119(a) of an application entitled “Method for Simplifying Maintenance of Feature of Three-dimensional Mesh Data,” filed in the Korean Intellectual Property Office on Sep. 12, 2006 and assigned Serial No. 2006-88012, the contents of which are hereby incorporated by reference.

### BACKGROUND OF THE INVENTION

1. Field of the Invention

The present invention relates to a method of simplifying the maintenance of three-dimensional mesh data, and more particularly to a method of simplifying the maintenance of a particular feature of the three-dimensional mesh data, wherein three-dimensional range scan data is used to find a feature line from a model, and an error metric is calculated with regard to the feature and geometric model so as to simplify the maintenance of the model's feature.

2. Description of the Related Art

As a result of a rapid development in three-dimensional range scanning systems in recent years, very complicated three-dimensional models obtained for many different applications including medical images, animations, games, and reverse engineering. By using such a system, even an object with a very complicated shape can be modeled quickly, accurately, and automatically.

Various fields, including three-dimensional model visualization, geometric modeling, and computer graphics, require that feature lines (ridges and valleys) be extracted from a point set. This is because such extraction is crucial to mesh reconstruction, shape analysis, and model division.

Alternatively, a model shape feature is extracted to improve the visualization of the point set and facilitate the process of converting the point set into a triangular mesh. Hence, extraction of feature lines from the point set is closely related to the mesh surface reconstruction. This is because the reconstruction of a mesh surface is very sensitive to the feature of a model. Therefore, extraction of feature lines from a point set may be a pre-processing step of mesh reconstruction. For example, when feature lines are directly extracted from three-dimensional mesh data, various operators need to be used. Such techniques require that the mesh operator conduct complicated processes, including filtering, thinning, and smoothing steps. Among them, an implicit surface fitting technique tend to yield good results, but it has the problem of a long feature extraction time. This is because, in order to measure the curvature tensor and curvature derivative value for each vertex of the mesh, the implicit surface needs overall approximation and projection.

In addition, the method for extracting line-type features from a point set of three-dimensional mesh data requires complicated steps, including weighting feature portions, constructing a surface, setting a threshold, and smoothing. Accordingly, a user unfamiliar with this method cannot obtain good results until it is tried a number of times.

For example, in order to find line-type features from point-sampled data, a multi-scale classification operator is employed. However, this operator cannot accurately differentiate between ridge and valley lines in order to find feature lines. As such, conventional methods have a problem in that it is impossible to maintain feature portions solely based on the quadric error metric and discrete error related to the contour of a model. Moreover, important features are removed together during a creation process to obtain a simpler model.

### SUMMARY OF THE INVENTION

Accordingly, the present invention has been made to solve the above-mentioned problems occurring in the prior art and provides additional advantages, by providing a method for simplifying the maintenance of a feature of three-dimensional mesh data, wherein three-dimensional range scan data is used to find a feature line from a model, and an error metric is calculated with regard to the feature and geometric model.

Another aspect of the present invention is to provide a method for simplifying the maintenance of a feature of three-dimensional mesh data, wherein a complicated three-dimensional mesh model is simplified at a level desired by a user so as to reduce the time and cost related to the manual treatment of a three-dimensional geometric model by a designer.

In accordance with an aspect of the present invention, there is provided a method for simplifying the maintenance of a feature of three-dimensional mesh data, the method including the steps of (a) creating a surface approximated with regard to each point of the three-dimensional mesh data; (b) measuring a curvature and a curvature derivative value regarding each point on the surface; (c) measuring zero-crossing at an edge of the mesh data so as to extract feature points; (d) creating a feature line by connecting the feature points in a curvature direction; and (e) calculating an edge and a quadric error metric regarding the feature line so as to maintain the feature.

### BRIEF DESCRIPTION OF THE DRAWINGS

The above aspects, features and advantages of the present invention will be more apparent from the following detailed description taken in conjunction with the accompanying drawings, in which:

FIG. 1 is a flowchart showing a method for maintaining a feature of three-dimensional mesh data according to an embodiment of the present invention;

FIG. 2 shows an example of three-dimensional mesh data according to an embodiment of the present invention;

FIG. 3a shows an example of a surface approximated from three-dimensional mesh data according to an embodiment of the present invention;

FIG. 3b shows an example of a process for MLS approximation from three-dimensional mesh data according to an embodiment of the present invention;

FIGS. 4a to 4d show processes for measuring zero-crossing from a surface, which has been subjected to MLS approximation in FIG. 3;

FIG. 5 illustrates the step for calculating the edge and quadric error metric regarding a feature line shown in FIG. 1;

FIG. 6 is a flowchart showing detailed steps of the step for calculating the edge and quadric error metric regarding three-dimensional mesh data shown in FIG. 1;

FIG. 7 shows examples of the quadric error metric and edge regarding a feature line of three-dimensional mesh data according to an embodiment of the present invention;

FIG. 8 shows an example of edge collapse regarding a feature line shown in FIG. 7; and

FIGS. 9a and 9b show examples of simplification of the maintenance of a feature of three-dimensional mesh data according to an embodiment of the present invention.

### DETAILED DESCRIPTION OF THE EXEMPLARY EMBODIMENT

Hereinafter, exemplary embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. For the purposes of clarity and simplicity, a detailed description of known functions and configurations incorporated herein will be omitted as it may make the subject matter of the present invention unclear.

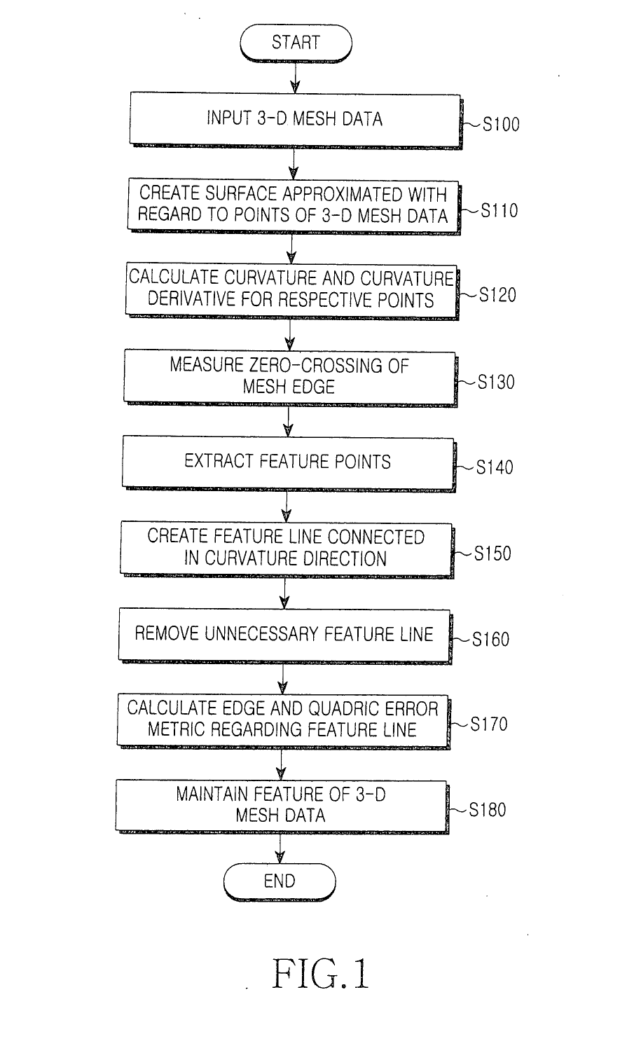

FIG. 1 is a flowchart showing a method for maintaining a feature of three-dimensional mesh data according to an embodiment of the present invention.

As shown in FIG. 1, briefly, the inventive method includes the steps of receiving an input of three-dimensional mesh data from a three-dimensional range scanning system; creating a surface approximated with regard to point data of the three-dimensional mesh data; measuring the curvature and curvature derivative value for respective points on the surface; measuring the zero-crossing at respective points so as to extract feature points; connecting the feature points in the curvature direction so as to create a feature line; and calculating and maintaining the edge and quadric error metric regarding the feature line.

The method for maintaining a feature of three-dimensional mesh data according to an embodiment of the present invention, which includes the above-mentioned steps, will now be described in detail with reference to the rest of the accompanying drawings.

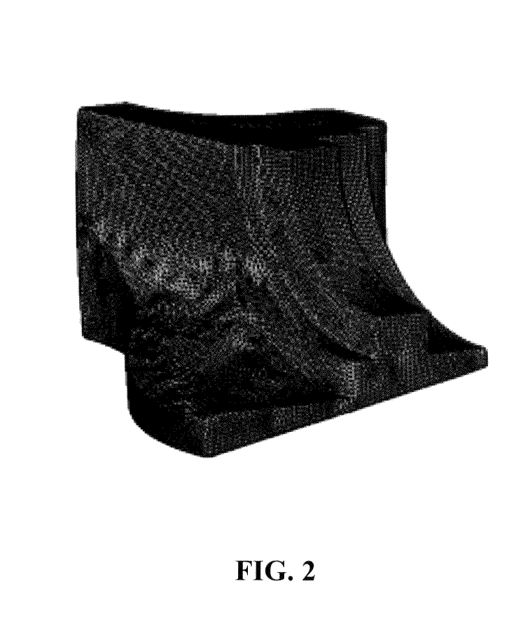

FIG. 2 shows an example of three-dimensional mesh data according to an embodiment of the present invention.

In step S100, an input of three-dimensional mesh data is received from a three-dimensional range scanning system.

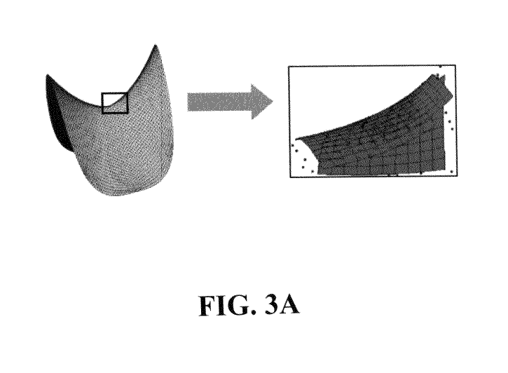

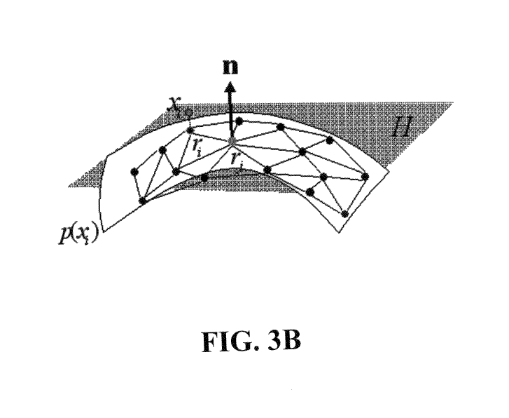

FIG. 3a shows an example of a surface approximated from a three-dimensional mesh data according to an embodiment of the present invention.

In step S110, an MLS (Moving Least Squares) approximation technique is used to create a surface approximated with regard to points of the three-dimensional mesh data. Particularly, the MLS approximation technique creates a function for approximating peripheral points of a given point with minimum error. Then, the given point is projected onto a surface defined by each approximation function with regard to every point data so as to define the surface of an object guaranteeing 2-manifold.

FIG. 3b shows an example of a process for MLS approximation from the three-dimensional mesh data according to an embodiment of the present invention.

For point r∈ R³, its neighboring points are Pᵢ∈ R³, i∈ {1, . . . ,N}. An approximate surface is defined on reference plane H, onto which point r is projected.

If a dense, smooth surface is given, main curvatures Kₘₐₓ and Kₘᵢₙ and main curvature directions tₘₐₓ and tₘᵢₙ are measured with regard to point r on the smooth surface, for example. In this case, Kₘₐₓ and Kₘᵢₙ refer to maximum and minimum curvatures, respectively (Kₘₐₓ>Kₘᵢₙ), and have tₘₐₓ and tₘᵢₙ, which coincide with the main curvature direction.

The derivative of Kₘₐₓ and Kₘᵢₙ in directions tₘₐₓ and tₘᵢₙ is: eₘₐₓ=∇Kₘₐₓ·tₘₐₓ, eₘᵢₙ=∇Kₘᵢₙ·tₘᵢₙ. The direction cannot be measured at the umbilical point (Kₘₐₓ=Kₘᵢₙ), which is excluded, because such points occur rarely and hardly affect the result of the feature line.

The zero-crossing with the extreme value of the main curvatures in the main curvature direction is defined by equation (1) below.
∇eₘₐₓ·tₘₐₓ<0, Kₘₐₓ>|Kₘᵢₙ|(ridge)
∇eₘₐₓ·tₘₐₓ>0, Kₘₐₓ<−|Kₘᵢₙ|(valley) (1)

After the main curvatures are compared, if a point has the maximum curvature, and if the curvature derivative value in the main curvature direction is smaller than 0 in that point, it is called a ridge.

In step S120, the curvature and curvature derivative value are calculated for each point on the surface. Third-degree polynomial p is used to measure the curvatures (Kₘₐₓ and Kₘᵢₙ) and curvature derivatives (eₘₐₓ and eₘᵢₙ) at each mesh vertex. Then, given MLS polynomial z=p(xᵢ) is converted into implicit function F=z−p(xᵢ) and calculated. As a result, the curvature and its derivative value can be measured from the implicit surface.

For given point r, the unit normal vector at point r is measured by using n=(n₁,n₂,n₃)=∇F/|∇F|. Main curvature K in main curvature direction t=(t₁,t₂, t₃) can be measured as defined by equation (2) below.

$$K = \frac{{F}_{ij} {t}^{i} {t}^{j}}{\vert ∇ F \vert} , \qquad ( 2 )$$

wherein Fᵢⱼ refers to second-order partial derivative of F and is used as Einstein summation convention. Based on eigenanalysis of ∇n, the minimum value in direction tₘᵢₙ and the maximum value in direction tₘₐₓ are measured. Curvature derivative e in the same direction t as the third-order partial derivative of F is defined by equation (3) below.

$$e = ∇ K \cdot t = \frac{{F}_{ij} {t}^{i} {t}^{j} {t}^{l} + 3 {KF}_{ij} {t}^{i} {n}^{j}}{\vert ∇ F \vert} , \qquad ( 3 )$$

wherein F refers to the third-order partial derivative of F. Equation (3) is used to measure eₘₐₓ and eₘᵢₙ at point r.

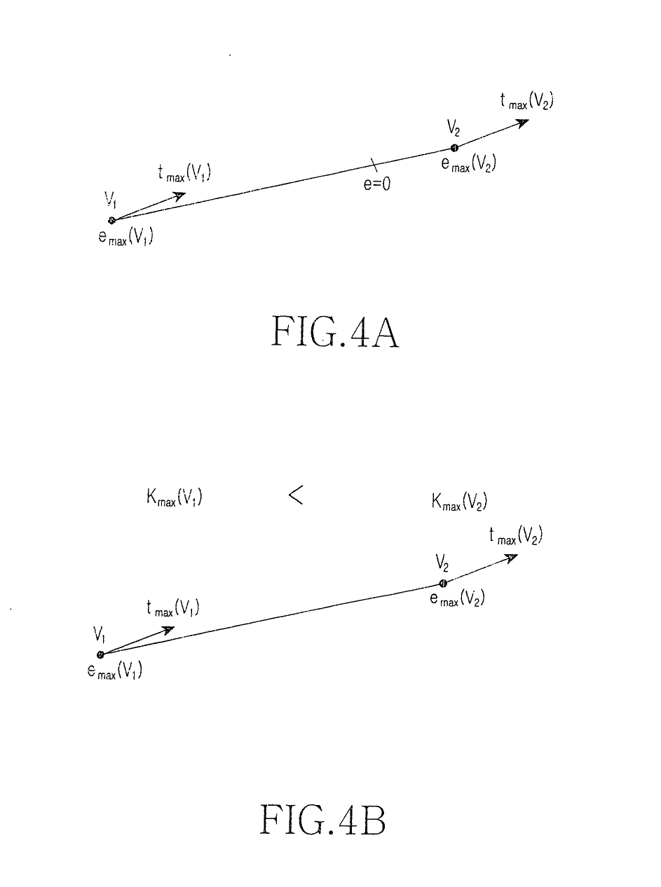

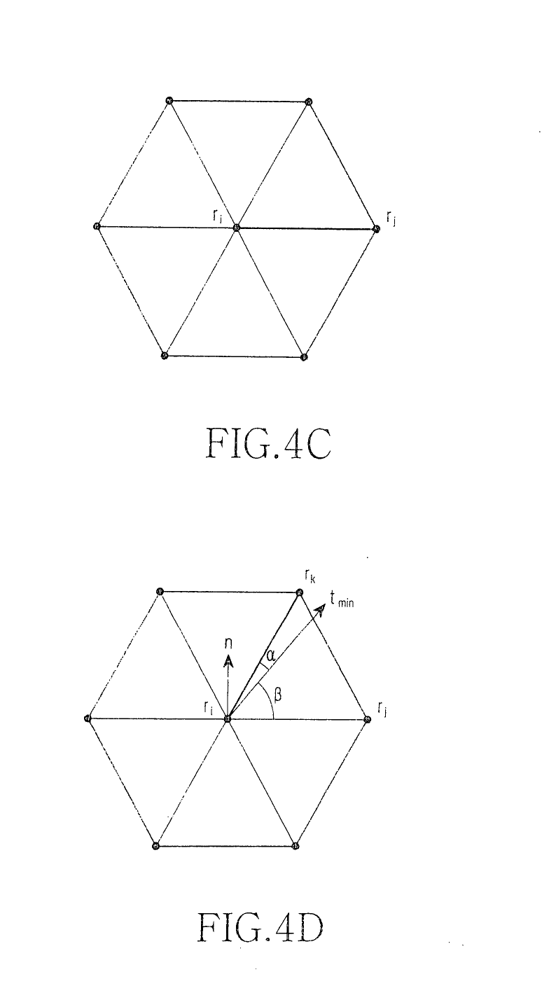

FIGS. 4a to 4d show processes for measuring zero-crossing from a surface, which has been subjected to MLS approximation in FIG. 3.

In step S130, zero-crossing at a Delaunay edge, i.e. information regarding neighbors connecting respective points, is measured to find a ridge point.

For given Delaunay edge [rᵢ,rᵢ₊₁], the angle between tₘₐₓ(rᵢ) and tₘₐₓ(rᵢ₊₁) is measured and, if it is obtuse, the signs of tₘₐₓ(rᵢ₊₁) and eₘₐₓ(rᵢ₊₁) are changed.

In order to measure the MCD (Maximum of the Curvature Derivatives) at each point, zero-crossing on Delaunay edge [rᵢ,rᵢ₊₁] is measured.

$${K}_{max} ( {r}_{I} ) > \vert {K}_{min} ( {r}_{i} ) \vert and \\ {MCD}_{max} ( {r}_{i} ) = \{ \begin{matrix}1 & {e}_{max} ( {r}_{i} ) > 0 , 0 & {e}_{min} ( {r}_{i} ) < 0 \\ 0 & {e}_{min} ( {r}_{i} ) = 0 & \end{matrix} \} \qquad ( 4 )$$

The sign of the curvature derivative is checked to conform if zero-crossing has occurred.
MCDₘₐₓ(rᵢ)ˆMCDₘₐₓ(rᵢ₊₁)=1 (5),

wherein ˆ refers to exclusive OR operator. It can be said that, if equation (5) is satisfied, zero-crossing exists between two points.
rᵢ=Kₘₐₓ(rᵢ)>Kₘₐₓ(rᵢ₊₁)
rᵢ₊₁=Kₘₐₓ(rᵢ)<Kₘₐₓ(rᵢ₊₁) (6)

In step S140, equation (6) is used to compare the size of curvature between two points and extract a point having a larger value as the ridge.

In step S150, each ridge point is converted into a line in the following manner: a ridge point is selected randomly, and one of its neighbors is measured. If it has an adjacent ridge point, it is connected to that point. It two or more ridge points exist, the main curvature direction is checked to select a ridge point positioned in the main curvature direction. This process is repeated to create a ridge line, as shown in FIG. 4d. For convenience of description and avoid redundancy, extraction of a valley line will be omitted herein, because it can be extracted in a similar manner as the ridge line.

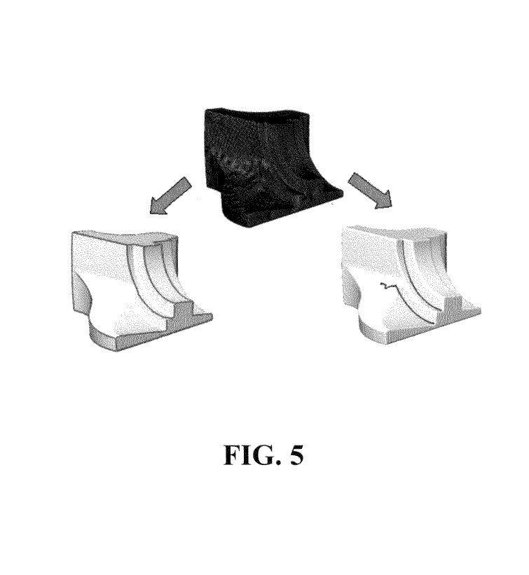

FIG. 5 shows an example of ridge and valley lines created by measuring the zero-crossing from a surface, which has been subjected to MLS approximation in FIG. 4.

In step S160, unnecessary feature lines are removed from the feature lines, i.e. ridge and valley lines. Particularly, a filtering technique is used to created a threshold as defined in equation (7) below, based on the edge length and the curvature metric (σ=K²) regarding each ridge line.

$$1 \leq i \leq n \text{:} T = \frac{1}{n} {\sum }_{i = 1}^{n} {\vert {r}_{i + 1} - {r}_{i} \vert}^{2} \cdot \frac{δ ( {r}_{i} ) + δ ( {r}_{i + 1} )}{2} , \qquad ( 7 )$$

wherein rᵢ refers to a ridge point from a set of n points, and it is meant by T that every line smaller than a value designated by the user is removed. In other words, lines shorter than the threshold or those at a point having a curvature smaller than the threshold are removed.

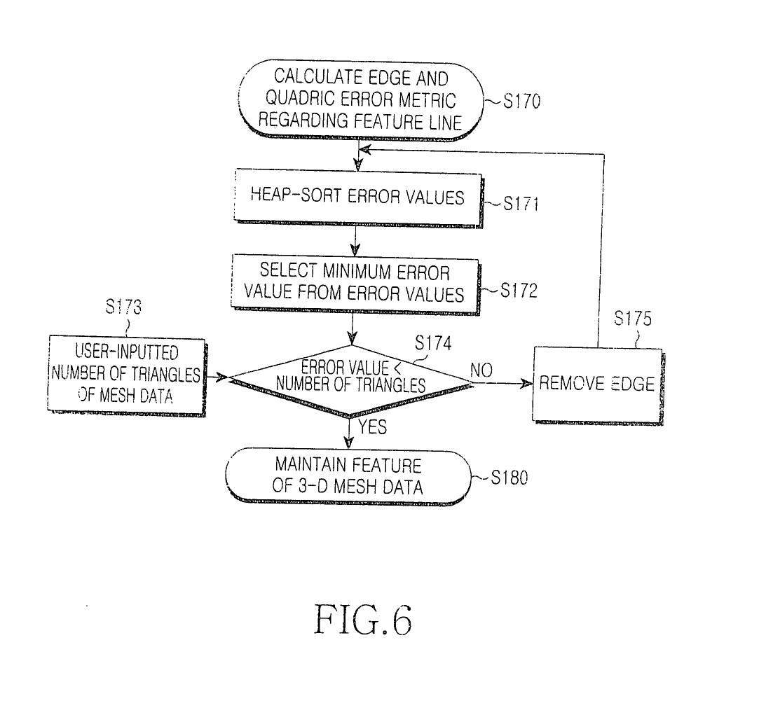

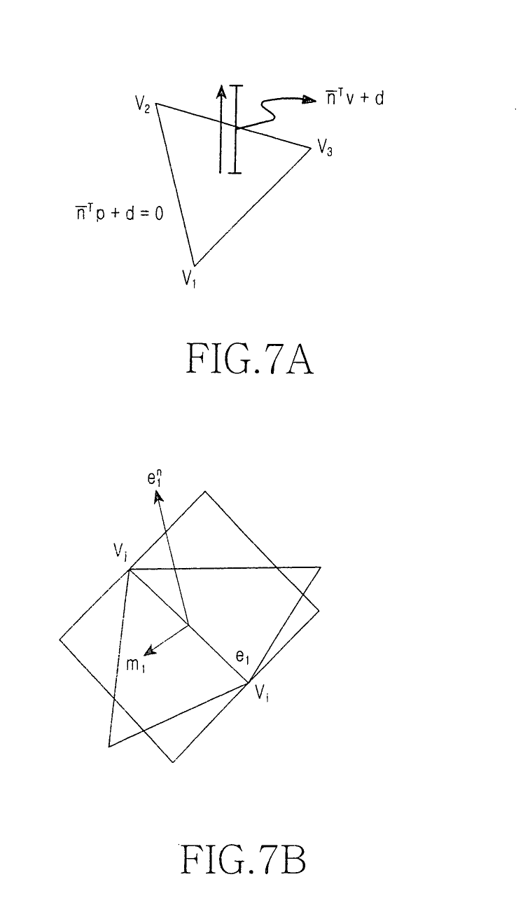

FIG. 6 is a flowchart showing detail steps for calculating the edge and quadric error metric regarding three-dimensional mesh data shown in FIG. 1, and FIG. 7 shows examples of the quadric error metric and edge regarding a feature line of three-dimensional mesh data according to an embodiment of the present invention.

In step S170, a quadric error metric is calculated by adding the squared distance between each point and a plane as defined by equation (8) below.

$${Q}^{f} ( V ) = {( {n}^{- T} v + d )}^{2} = {V}^{T} AV + 2 {b}^{T} V + c \\ {Q}^{v} ( p ) = {\sum }_{{v}_{1} ∈ f} {Q}^{f} + {\sum }_{{v}_{2 cf}} {Q}^{j} \qquad ( 8 )$$

An edge equation is defined by equation (9) below.

$${e}_{1} = {V}_{j} - {V}_{i} \\ {e}_{1}^{n} = \frac{{V}_{j} - {V}_{i}}{\vert {V}_{j} - {V}_{i} \vert} \\ {m}_{e} = ( {e}_{1} \times {e}_{1}^{n} ) \\ {Q}_{v} = ( {\sum }_{{f}_{a} {∈}_{e}} {m}_{{f}_{e}} ) {( {\sum }_{{f}_{a} {∈}_{e}} {m}_{{f}_{a}} )}^{T} \qquad ( 9 )$$

The result from the edge equation (9) is combined with that from the quadric error metric equation (8) to give error value Q defined by equation (10) below.
Q=Qₚ+Q_{fe} (10)

In step S171, the error value calculated in step S170 is heap-sorted. As used herein, the heap refers to a material structure making it possible to find a node with the largest or smallest key value from a number of nodes during a short period of time. The heap is also referred to as a priority queue, which literally means a queue having priority.

For example, the maximum heap is a completely binary tree, and a node of the heap has a key value larger than that of every one of its offspring node. The root of the maximum node is always occupied by a node having the largest key value. Therefore, this type of material structure is suited to construct the priority queue.

In step S172, the minimum error value is selected from the error values Q sorted in step S171. In step S173, the external user inputs the number of triangles of mesh data he/she wants to reduce. In step S174, they are compared.

In step S180, if the error value Q is smaller than the number F of triangles as a result of comparison in step S174, the three-dimensional mesh mode is simplified at a level desired by the user while maintaining the feature line.

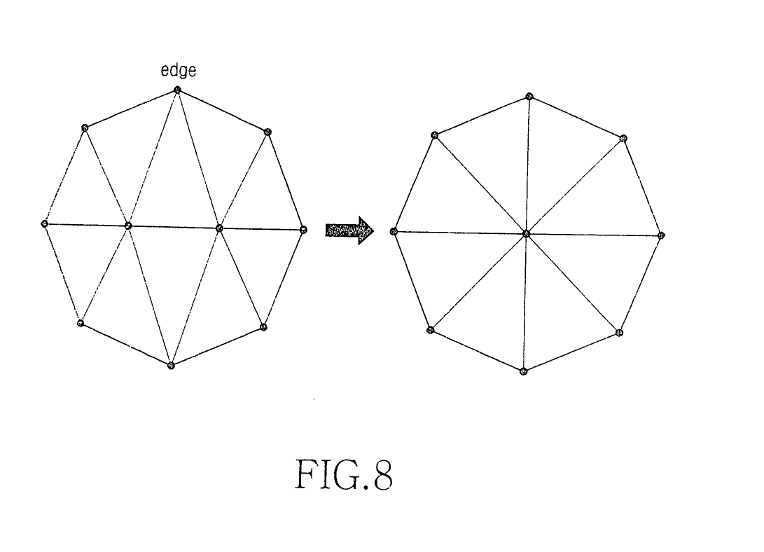

FIG. 8 shows an example of edge collapse regarding a feature line shown in FIG. 7.

In step S175, the edge is removed (edge collapse) if the error value Q is larger than the number F of triangles. For example, both vertices of the edge are combined into one, as shown in FIG. 8. Then, the calculation of edge and quadric error metric is repeated with regard to neighboring surfaces of the feature line. If the number desired by the user is reached, the three-dimensional mesh model is simplified at a level desired by the user while maintaining the feature portion.

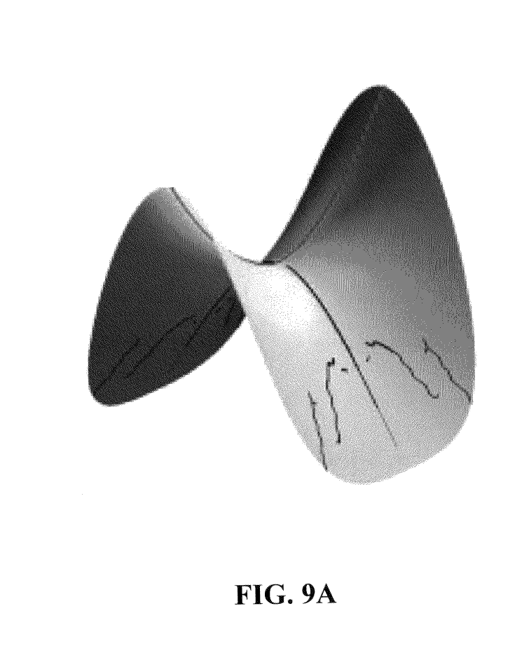

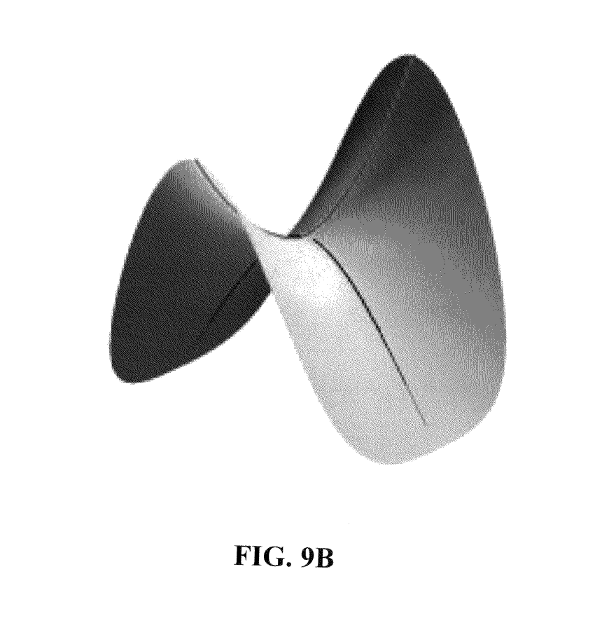

FIGS. 9a and 9b show examples of simplification of the maintenance of a feature of three-dimensional mesh data according to an embodiment of the present invention.

As mentioned above, the method for simplifying the maintenance of a feature of three-dimensional mesh data according to the present invention is advantageous in that three-dimensional range scan data is used to find a feature line from a model, then an error metric is calculated with regard to the feature and geometric model so as to simplify the maintenance of the model's feature. As a result, a complicated three-dimensional mesh model is simplified at a level desired by a user so as to reduce the time and cost related to manual treatment of a three-dimensional geometric model by a designer.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for simplifying the maintenance of a feature of three-dimensional mesh data, the method comprising the steps of:
(a) creating a surface approximated with regard to each point of the three-dimensional mesh data;
(b) measuring a curvature and a curvature derivative value regarding each point on the surface;
(c) measuring a zero-crossing at an edge of the mesh data so as to extract feature points;
(d) creating a feature line by connecting the feature points in a curvature direction; and
(e) calculating an edge and a quadric error metric regarding the feature line so as to maintain the feature.

2. The method as claimed in claim 1, wherein an MLS approximation technique is used in step (a).

3. The method as claimed in claim 2, wherein the MLS approximation technique approximates peripheral points of a point with minimum error.

4. The method as claimed in claim 1, wherein the zero-crossing is measured by checking a sign of the curvature derivative.

5. The method as claimed in claim 4, wherein a feature point having a large value is selected by comparing a curvature size of each feature point after measuring the zero-crossing.

6. The method as claimed in claim 5, wherein the feature point comprises a ridge and a valley.

7. The method as claimed in claim 6, wherein the feature line is created by connecting feature points having at least two neighbors in a main curvature direction.

8. The method as claimed in claim 1, wherein step (d) comprises a step of removing an unnecessary feature line.

9. The method as claimed in claim 1, wherein step (e) comprises the steps of:
heap-sorting error values by calculating the edge and the quadric error metric regarding the feature line;
selecting a minimum error value from the error values;
comparing the selected error value with a number of triangles of mesh data inputted by a user; and
maintaining the feature line when the error value is smaller than the number of triangles according to the comparison.

10. The method as claimed in claim 9, wherein the error value is a sum of an error of a squared distance regarding the feature line and the edge.

11. The method as claimed in claim 9, wherein the step of maintaining the feature line comprises the steps of:
removing the edge when the error value is larger than the number of triangles; and
repeatedly calculating the edge and the quadric error metric regarding neighboring surfaces of the feature line.
